(19) United States
(12) Patent Application Publication
(10) Pub. No.: US 2010/0068100 A1
(43) Pub. Date: Mar. 18, 2010

(54) Sample Carrier

(75) Inventors: Dieter Voegelin, Sissach (CH); Olaf Grassmann, Lorrach (DE)

Correspondence Address: MINTZ LEVIN COHN FERRIS GLOVSKY & POPEO, ONE FINANCIAL CENTER, BOSTON, MA, 02111, US

(73) Assignee: F. Hoffmann-La Roche AG, Basel (CH)

(21) Appl. No.: 12/583,535

(22) Filed: Aug. 20, 2009

(30) Foreign Application Priority Data
Aug. 26, 2008 (EP) 08162930.5

(51) Int. Cl. B01L 3/00

(52) U.S. Cl. 422/102

(57) ABSTRACT

Some embodiments of the present disclosure include a sample carrier for biologically active samples, in particular for toxic samples and especially for highly toxic samples. Such embodiments include a bottom part, a first membrane, a spacer, a second membrane and a lid. The bottom part and the lid may be connectable such that the first membrane, the spacer and the second membrane are enclosed between the bottom part and the lid. The bottom part and the lid may include means for a non-detachable form-locking connection between the bottom part and the lid.

### CROSS-REFERENCE TO RELATED APPLICATIONS

The present application claims priority to European Patent Application No. 08162930.5, filed Aug. 26, 2008, the entire contents of which are herein incorporated by reference in its entirety.

### FIELD OF THE INVENTION

The present invention relates to a sample carrier for biologically active samples, in particular for toxic samples and especially for highly toxic samples according to the preamble of the independent claim. More specifically, the invention relates to a sample carrier used in X-ray diffractometry.

### BACKGROUND

The term “biologically active sample” refers to a substance that has an effect (beneficial or adverse) on the metabolic activity of living cells. In particular, the term “biologically active substances include “toxic” and “highly toxic” samples as will be discussed below.

The term “toxic” refers to a substance which falls in any of the following three categories:
a substance that has a median lethal dose (LD50) of more than 50 milligrams per kilogram but not more than 500 milligrams per kilogram of body weight when administered orally to albino rats weighing between 200 and 300 grams each;
a substance that has a median lethal dose (LD50) of more than 200 milligrams per kilogram but not more than 1,000 milligrams per kilogram of body weight when administered by continuous contact for 24 hours (or less if death occurs within 24 hours) with the bare skin of albino rabbits weighing between two and three kilograms each; and
a substance that has a median lethal concentration (LC50) in air of more than 200 parts per million but not more than 2,000 parts per million by volume of gas or vapor, or more than two milligrams per liter but not more than 20 milligrams per liter of mist, fume, or dust, when administered by continuous inhalation for one hour (or less if death occurs within one hour) to albino rats weighing between 200 and 300 grams each.

The term “highly toxic” refers to a substance that falls in any of the following three categories:
a substance that has a median lethal dose (LD50) of 50 milligrams or less per kilogram of body weight when administered orally to albino rats weighing between 200 and 300 grams each;
a substance that has a median lethal dose (LD50) of 200 milligrams or less per kilogram of body weight when administered by continuous contact for 24 hours (or less if death occurs within 24 hours) with the bare skin of albino rabbits weighing between two and three kilograms each; and
a substance that has a median lethal concentration (LC50) in air of 200 parts per million by volume or less of gas or vapor, or 2 milligrams per liter or less of mist, fume, or dust, when administered by continuous inhalation for one hour (or less if death occurs within one hour) to albino rats weighing between 200 and 300 grams each.

X-ray diffractometry is a well known method. In a specific application of X-ray diffractometry, a powder having a crystalline structure is irradiated with X-rays. The powder diffracts the X-rays similar to a diffraction grid, and maxima of the diffracted X-rays are scanned with a detector. The location and intensity of the maxima are representative of the crystalline structure of the powder.

Working with such biologically active samples requires sample carriers that are absolutely leakproof. Even a smallest contamination by such samples may require expensive decontamination of the laboratory and the equipment. It is also important to ensure that no humidity can get inside the sample carrier, as the powder may absorb the humidity, which may result in a change of the crystalline structure of the powder, thus falsifying the results of the measurements.

Known sample carriers for biologically active samples comprise a base carrier, onto which a first membrane and a spacer are placed. The spacer comprises an opening for receiving the biologically active sample. Once the biologically active sample has been deposited on the first membrane in the opening of the spacer, the spacer is closed by a second membrane and a further spacer. The spacer and the further spacer each have an opening for the X-rays to pass through, whereas the membranes are made of a material that is permeable to X-rays. The further spacer is fixed to the base carrier thus pressing the first membrane, the spacer and the second membrane against the base carrier by means of screws.

The known sample carriers for biologically active samples are difficult to assemble and it may occur that the screws are not sufficiently tightened or that they are inserted and screwed in slightly inclined. As a consequence, there is a risk that the components of the sample carrier could loosen or fall apart and may release the biologically active sample or at least a small amount thereof, which may result in contamination of the laboratory and/or the equipment.

### SUMMARY OF THE INVENTION

It is therefore an object of at least some of the embodiments of the invention to suggest a sample carrier for biologically active samples, in particular for toxic samples and especially for highly toxic samples, which does not have the above-mentioned disadvantages, that is to say a sample carrier for biologically active samples which is easy to assemble and which reliably prevents the components of the carrier from loosening or even from falling apart. In addition, the suggested sample carrier for biologically active samples, according to some embodiments, is hermetically closed, so as to not allow humidity, liquids or gases to enter or exit, or to come into contact with the environment in general. Furthermore, the suggested sample carrier for biologically active samples according to some embodiments is simple in construction and assembly.

This objective may be achieved by the sample carrier according to some embodiments of the invention as it is characterised, for example, by the features of the independent claim. Moreover, advantageous embodiments of the sample carrier according to the invention become apparent from the features of the dependent claims as well, for example.

In particular, according to some embodiments of the invention, a sample carrier may be provided which comprises one or more (and preferably all) of a bottom part, a first membrane, a spacer, a second membrane and a lid. The bottom part and the lid are connectable in such a way, that the first membrane, the spacer and the second membrane are enclosed between the bottom part and the lid. The bottom part and the lid may include means for a non-detachable form-locking connection of the bottom part and the lid. By using such means for a non-detachable form-locking connection of the bottom part and the lid, the components of the sample carrier may be prevented from loosening or even from falling apart. In addition, the sample carrier may be hermetically sealed, thus not allowing humidity, liquids or gases to enter or exit, or to come into contact with the environment in general, for example.

The term “hermetically sealed”, according to some embodiments, protects individuals who handle the sample carrier from coming into contact with the substances and/or that the substances are protected from coming into contact with the environment (e.g. the substances are protected against drying or from coming into contact with oxygen). In such cases, therefore, there is no risk that the biologically active sample or at least a small amount thereof may be released, so that contamination of the laboratory and the equipment can be avoided. Furthermore, the suggested sample carrier for biologically active samples according to some embodiments is simple in construction, inexpensive to produce and easy to assemble. Additionally, the sample carrier can allow storage of a sample for a comparatively long period of time within the sample carrier.

In some further embodiments of the sample carrier according to the invention, the means for a non-detachable connection, which may also be form-locking, of the bottom part and the lid may comprise a snap-fit means. Such snap-fit means are simple and reliable for forming a non-detachable and/or form-locking connection.

In some further embodiments of the sample carrier according to the invention, the snap-fit means may comprise an undercut at the bottom part and resiliently deformable claws at the lid. Such a configuration allows for a simple and inexpensive realisation of the snap-fit means.

In some further embodiments of the sample carrier according to the invention, the spacer may comprise at least one circular opening for the passage of X-rays. The at least one circular opening of the spacer may allow not only the passage of the X-rays used for the X-ray diffractometry, but may also provide for a storage space between the first and second membrane for storing the biologically active sample to be analysed, for example.

In some further embodiments of the sample carrier according to the invention, the sample carrier may comprise a first adhesive layer between the bottom part and the first membrane and a second adhesive layer between the lid and the second membrane. The use of first and second adhesive layers is a simple way to further improve the hermetical seal of the biologically active sample and to simplify the assembly of the sample carrier. In addition, it may also provide for a seal that is proof against diffusion and preferably is also resistant to solvents. By way of example, acrylic adhesives may be suitable for that purpose.

In some further embodiments of the sample carrier according to the invention, the bottom part and the lid may be made of a plastic, which may preferably be of POM, PP or PEEK. Polyoxymethylene (POM), also called polyacetale and polypropylene (PP) are materials that are suitable for the simple and inexpensive production of the bottom part and the lid of the sample carrier. Polyetheretherketone (PEEK) is also a material suitable for that purpose. Although more expensive, PEEK is particularly suitable when inert conditions are required (e.g. when the sample materials are highly reactive).

In some further embodiments of the sample carrier according to the invention, the lid may be equipped with an O-ring. An O-ring is also a simple and inexpensive way to further improve the hermetical seal of the biologically active sample, for example.

In some further embodiments, such an O-ring may be embedded into the lid during manufacturing (e.g. during injection molding) so as to form an integral part thereof.

In some further embodiments of the sample carrier according to the invention, the first and second membranes may comprise an X-ray permeable material, e.g. Mylar® or Kapton®. In some embodiments, for X-ray diffractometry, the X-rays should pass through the first and second membranes. Mylar® (biaxially-oriented polyethylene terephthalate) or Kapton® (polyimide), for example, are suitable and inexpensive materials for this purpose.

In some further embodiments of the sample carrier according to the invention, the bottom part and the lid may include a circular shape. In such embodiments, this is advantageous as a lot of measurement and handling equipment is already available and is adapted to accommodate sample carriers having a circular shape.

In some further embodiments of the sample carrier according to the invention, the resiliently deformable claws of the snap-fit means may be equidistantly arranged on the lid, when viewed in circumferential direction. Such an arrangement provides for a safe and uniform connection of the bottom part and the lid of the sample carrier.

In some further embodiments of the sample carrier according to the invention, the spacer may comprise a plurality of openings for receiving different biologically active samples. This enables the storage of different biologically active samples in one single sample carrier. It is possible to analyse each sample independently one after another or simultaneously.

According to a further aspect of the invention, the above-described sample carrier can form part of a multiplate structure which may comprise several recesses, for example, with each recess accommodating a sample carrier. Multiplates are standard laboratory components which are easy to handle and transport, and which are suitable to store the sample carriers before, during and after X-ray diffractometry, for example.

According to another further aspect of the invention, the above-described sample carrier can be part of a multiplate structure comprising several recesses, for example, with each recess accommodating a sample carrier (according to one or another embodiment of the present invention, where the bottom part of each sample carrier may be formed by the corresponding recess of the multiplate. Such embodiments of a multiplate further simplify handling of sample carriers for biologically active samples whenever a large amount of samples have to be processed, for example.

Further advantages, objects and features of various embodiments of the present invention will become more evident from the following detailed description of the specific embodiments with the aid of the drawings.

### BRIEF DESCRIPTION OF THE FIGURES

FIG. 1 shows an exploded view of a sample carrier according to some embodiments of the invention;

FIG. 2 shows the sample carrier of FIG. 1 in a pre-assembled state ready to receive a biologically active sample and before getting closed;

FIG. 3 shows a section through the pre-assembled sample carrier of FIG. 2;

FIG. 4 shows the section of FIG. 3, with the sample carrier in a closed state;

FIG. 5 shows a perspective view of the sample carrier of FIG. 1 in a closed state;

FIG. 6 shows a perspective view of a sample carrier according to some embodiments of the invention;

FIG. 7 shows a perspective view of a multiplate according to some embodiments of the invention together with only one single sample carrier (for example); and

FIG. 8 shows the multiplate of FIG. 7 with a plurality of sample carriers corresponding to the numbers of recesses in the multiplate according to some embodiments of the present invention.

### DETAILED DESCRIPTION OF THE EMBODIMENTS

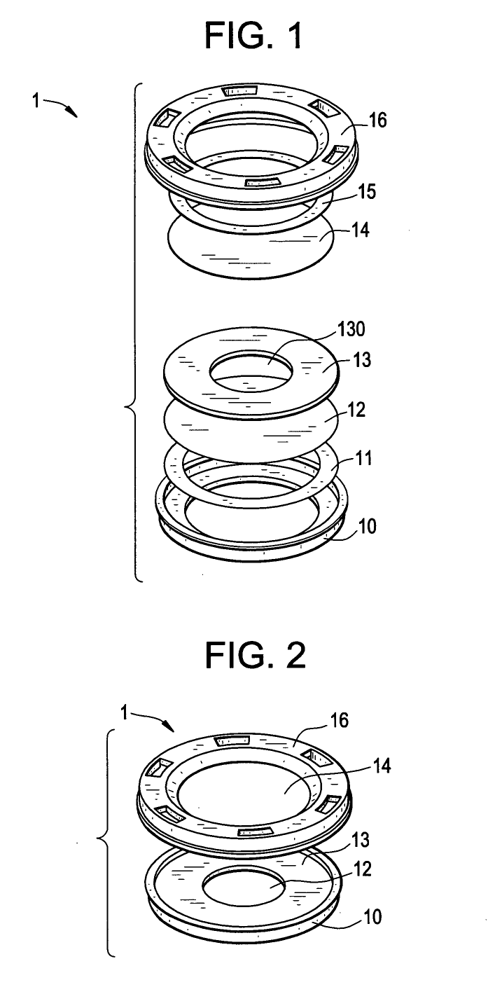

FIGS. 1-5 show a sample carrier 1 according to some embodiments of the invention, comprising—as best seen in FIG. 1—a bottom part 10 and a lid 16. The bottom part 10 and the lid 16 enclose between them a first membrane 12, a spacer 13 and a second membrane 14. The first membrane 12 is fixed to the bottom part 10 via a first adhesive layer 11, and the second membrane 14 is fixed to the lid 16 via a second adhesive layer 15. The spacer 13 has an opening 130, enabling the passage of X-rays and providing a storage space for the biologically active sample to be analysed.

Bottom part 10 and lid 16 may be made of a plastic, preferably of polyoximethylene (POM), also called polyacetale, of polypropylene (PP) or of polyetheretherketone (PEEK). The first 12 and second 14 membranes may comprise an X-ray permeable material, e.g. Mylar® (biaxially-oriented polyethylene terephthalate) or Kapton® (polyimide), so that the X-rays pass through the sample carrier during analysis of the biologically active sample in X-ray diffractometry. Spacer 13 can be made of a magnetic material, e.g. a magnetic metal, so as to allow transport of the sample carrier 1 by using a lift magnet (not shown).

FIG. 2 shows the sample carrier 1 of FIG. 1 in a pre-assembled state, ready to receive a biologically active sample and then to get closed. In this assembled state, the first adhesive layer 11 (see FIG. 1), the first membrane 12 and the spacer 13 may be mounted to the bottom part 10 while the second adhesive layer 15 (see FIG. 1) and the second membrane 14 may be mounted to the lid 16. The opening of spacer 13 is ready to receive the biologically active sample to be analysed. Once the biologically active sample has been deposited in the opening of the spacer 13 and on the first membrane 12, the lid 16 of the sample carrier 1 can be closed by connecting lid 16 to bottom part 10.

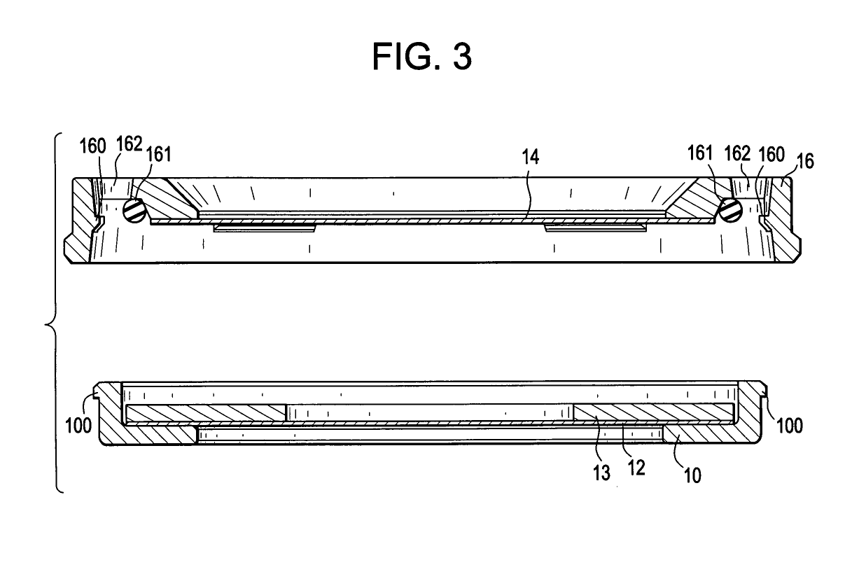

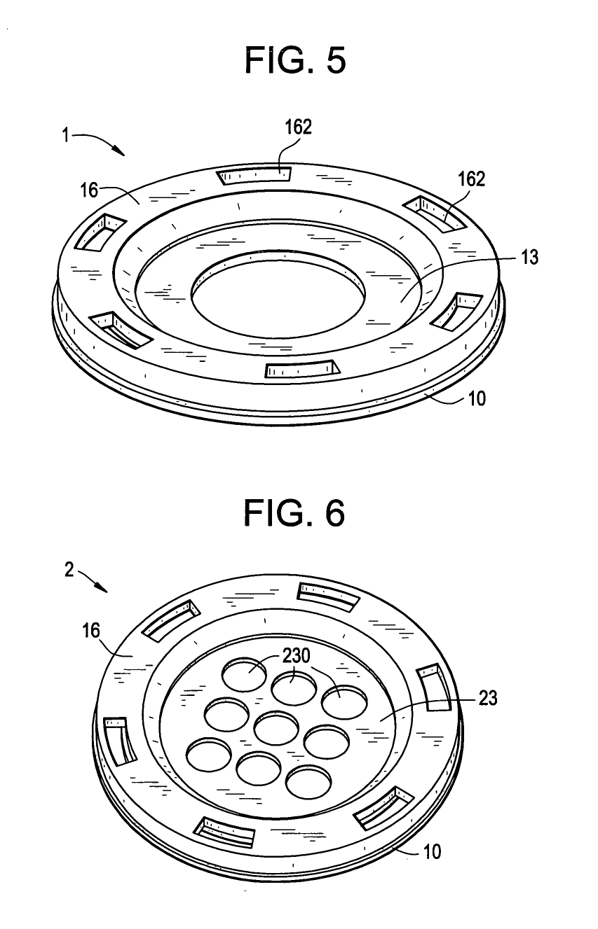

FIG. 3 shows a section of the pre-assembled sample carrier 1 of FIG. 2. As can be seen, bottom part 10 of the sample carrier may include an undercut 100. Lid 16 of the sample carrier may also include resiliently deformable claws 160 ready to receive undercut 100 of bottom part 10. Resiliently deformable claws 160 together with the undercut 100 preferably form a non-detachable form-locking connection of the snap-fit type, so that the sample carrier can be hermetically sealed. Openings 162 in lid 16 allow convenient manufacturing of the lid and facilitate operation of the resiliently deformable claws 160. In addition, lid 16 may also include an O-ring 161 to further improve a hermetical seal of the assembled sample carrier. Resiliently deformable claws 160 as well as the accompanying openings 162 may be equidistantly arranged on the lid 16 when viewed in circumferential direction (see FIG. 5). The O-ring 161 may or may not form an integral part of the lid 16 and may be embedded into the lid 16 during manufacturing thereof (e.g. during injection molding).

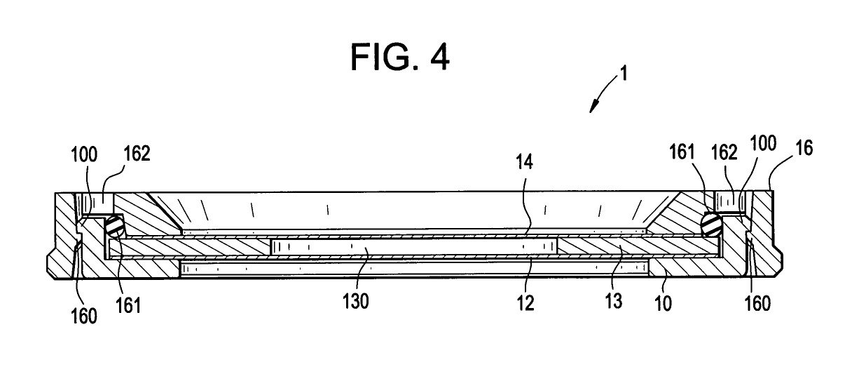

FIG. 4 shows the section of FIG. 3, however, with the sample carrier 1 being in a closed state, normally enclosing a biologically active sample (not shown) to be analysed using X-ray diffractometry. Opening 130 of the spacer 13 may be enclosed by first membrane 12 and second membrane 14. First membrane 12, spacer 13 and second membrane 14 may be enclosed between bottom part 10 and lid 16. The non-detachable form-locking connection of bottom part 10 and lid 16 is formed by the snap-fit formed by the undercut 100 of bottom part 10 and the resiliently deformable claws 160 of lid 16. O-ring 161 further improves the hermetical seal of the sample carrier.

FIG. 5 shows a perspective view of the exemplary embodiment of the sample carrier 1 according to the invention in its closed state.

FIG. 6 shows a perspective view of a sample carrier 2 according to some embodiments of the invention. Sample carrier 2 differs from the sample carrier shown in FIGS. 1-5 in that it includes a spacer 23 having a plurality of openings 230 for receiving different biologically active samples (for example). A bottom part 10 and a lid 16 enclose the spacer 23. Similar to the exemplary embodiments shown in FIGS. 1-5 of the sample carrier 1 according to the invention, sample carrier 2 may also include a first and a second membrane, connected by a first and second adhesive layers to the bottom part 10 and the lid 16, respectively.

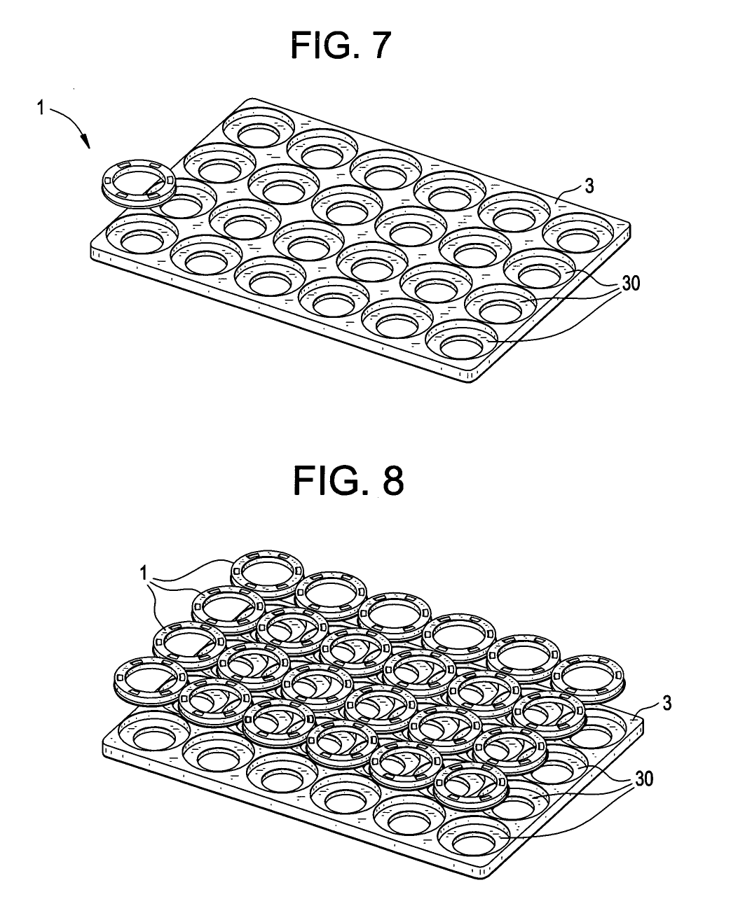

FIGS. 7 and 8 show a perspective view of an embodiment of a multiplate 3 according to the invention. Multiplate 3 may include several recesses 30, each recess 30 being ready for accommodating a sample carrier 1 as described above, for example. Multiplate 3 may receive as many sample carriers 1 as required, but is limited to the number of recesses 30 available on multiplate 3. Bottom part 10 (see FIGS. 1-6) of each sample carrier 1 may alternatively be formed by the corresponding recess 30 of the multiplate 3. In this way, pre-assembled multiplates can be prepared to which only the lids must be connected with the aid of the snap-fit connection.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims as well. The claims presented are representative of at least some of the embodiments and inventions disclosed herein. Other unclaimed embodiments and inventions are also contemplated and may be claimed in this or a related application.

What is claimed is:

1. A sample carrier for biologically active samples comprising:
a bottom part;
a first membrane;
a spacer;
a second membrane; and
a lid, wherein
the bottom part and the lid are connectable in such a way that the first membrane, the spacer and the second membrane are enclosed between the bottom part and the lid, and
the bottom part and the lid include means for a non-detachable form-locking connection of the bottom part and the lid.

2. A sample carrier according to claim 1, wherein the means for the non-detachable form-locking connection of the bottom part and the lid comprise snap-fit means.

3. A sample carrier according to claim 2, wherein the snap-fit means comprise an undercut provided with the bottom part and resiliently deformable claws provided with the lid.

4. A sample carrier according to claim 1, wherein the spacer comprises at least one circular opening for the passage of X-rays.

5. A sample carrier according to claim 1, wherein the sample carrier comprises a first adhesive layer between the bottom part and the first membrane and a second adhesive layer between the lid and the second membrane.

6. A sample carrier according to claim 1, wherein at least one of the bottom part and the lid are made of a plastic.

7. A sample carrier according to claim 6, wherein the plastic is selected from the group consisting of: polyoxymethylene, polyproylene and polyetheretherketone.

8. A sample carrier according to claim 1, wherein the lid includes an O-ring.

9. A sample carrier according to claim 8, wherein the O-ring is embedded into the lid.

10. A sample carrier according to claim 1, wherein the first and second membranes comprise an X-ray permeable material.

11. A sample carrier according to claim 10, wherein the X-ray permeable material is selected from the group consisting of: Mylar and Kapton.

12. A sample carrier according to claim 1, wherein the bottom part and the lid include a circular shape.

13. A sample carrier according to claim 3, wherein the resiliently deformable claws are substantially equidistantly arranged on the lid when viewed in circumferential direction.

14. Sample carrier according to claim 1, wherein the spacer comprises a plurality of openings for receiving different biologically active samples.

15. A multiplate comprising a structure including several recesses, wherein each recess accommodates a sample carrier according to claim 1.

16. A multiplate comprising a structure including several recesses, wherein each recess accommodates a sample carrier according to claim 1, and wherein the bottom part of each sample carrier is formed by a corresponding recess of the multiplate.
